(19) United States
(12) Patent Application Publication
(10) Pub. No.: US 2013/0247152 A1
(43) Pub. Date: Sep. 19, 2013

(54) ACCESS DEVICE, ACCESS SYSTEM AND COMPUTER PROGRAM PRODUCT

(71) Applicant: KABUSHIKI KAISHA TOSHIBA, Tokyo (JP)

(72) Inventors: Keisuke Minami, Kanagawa-ken (JP); Daisuke Ajitomi, Tokyo (JP); Hiroyuki Aizu, Kanagawa-ken (JP); Kotaro Ise, Kanagawa-ken (JP)

(73) Assignee: KABUSHIKI KAISHA TOSHIBA, Tokyo (JP)

(21) Appl. No.: 13/759,148

(22) Filed: Feb. 5, 2013

(30) Foreign Application Priority Data
Mar. 13, 2012 (JP) 2012-056267

(51) Int. Cl. G06F 21/30

(52) U.S. Cl. CPC G06F 21/30
USPC 726/4

(57) ABSTRACT

According to an embodiment, an access device includes a first obtaining unit configured to obtain a first authorization as user authorization; and a second obtaining unit configured to obtain a second authorization as authorization other than the user authorization through communication with a server via an external network. The access device also includes an accessing unit configured to access a function of an access target device via a local network by using the first authorization and the second authorization.

### CROSS-REFERENCE TO RELATED APPLICATION

This application is based upon and claims the benefit of priority from Japanese Patent Application No. 2012-056267, filed on Mar. 13, 2012; the entire contents of which are incorporated herein by reference.

### FIELD

Embodiments described herein relate generally to an access device, an access system and a computer program product.

### BACKGROUND

A known technique provides access authorization such as user authorization with a server on an external network in the event that an access device accesses an access target device.

### BRIEF DESCRIPTION OF THE DRAWINGS

FIG. 1 is a block diagram illustrating an exemplary access system according to a first embodiment;

FIG. 2 is a diagram illustrating an exemplary user authorization screen according to the first embodiment;

FIG. 3 is a sequence diagram illustrating an exemplary function access process according to the first embodiment;

FIG. 4 is a flowchart illustrating the exemplary function access process according to the first embodiment;

FIG. 5 is a block diagram illustrating an exemplary access system according to a second embodiment;

FIG. 6 is a diagram illustrating an exemplary user authorization screen according to the second embodiment;

FIG. 7 is a sequence diagram illustrating an exemplary function access process according to the second embodiment;

FIG. 8 is a flowchart illustrating the exemplary function access process according to the second embodiment;

FIG. 9 is a block diagram illustrating an exemplary access system according to a third embodiment;

FIG. 10 is a diagram illustrating an exemplary user authorization screen according to the third embodiment;

FIG. 11 is a diagram illustrating an exemplary user authorization screen according to the third embodiment; and

FIG. 12 is a schematic diagram illustrating a plurality of access target devices according to the third embodiment.

### DETAILED DESCRIPTION

According to an embodiment, an access device, includes a first obtaining unit configured to obtain a first authorization as user authorization; and a second obtaining unit configured to obtain a second authorization as authorization other than the user authorization through communication with a server via an external network. The access device also includes an accessing unit configured to access a function of an access target device via a local network by using the first authorization and the second authorization.

A description will be given of an embodiment in detail below by referring to the accompanying drawings.

### First Embodiment

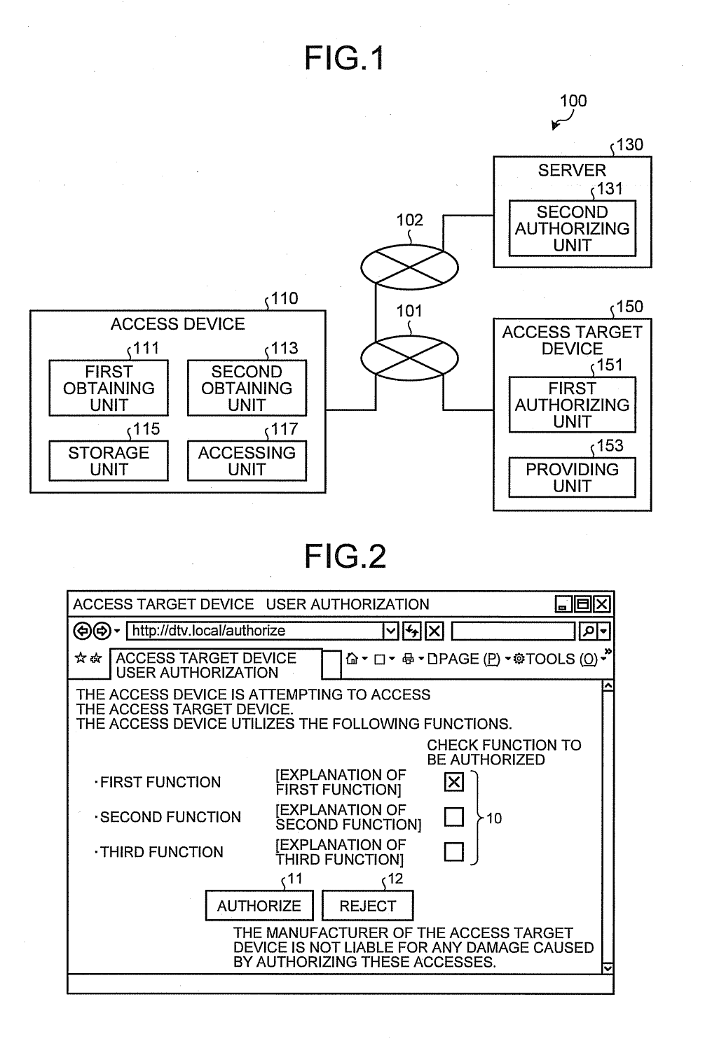

FIG. 1 is a block diagram illustrating an exemplary access system 100 according to a first embodiment. As illustrated in FIG. 1, the access system 100 includes an access device 110, a server 130, and an access target device 150.

The access device 110 is coupled to the access target device 150 via a local network 101. Both the access device 110 and the access target device 150 are coupled to the server 130 via the local network 101 and an external network 102.

The local network 101 is a network that is configured of a wireless local area network (LAN), Ethernet (registered trademark), and similar network. The local network 101 is achieved, for example, by various LANs such as a home LAN and a company LAN. In the first embodiment, a description will be given of an example where the local network 101 is a home LAN and both the access device 110 and the access target device 150 are in the same home. However, this embodiment is not limited to this.

The local network 101 is not limited to the aforementioned configuration. The local network 101 may be power line communications (PLC), a personal area network (PAN), a cellular network, or similar network. The PAN may be configured of, for example, a universal serial bus (USB), an infrared, Bluetooth (registered trademark), Zigbee (registered trademark), or similar method. In the case where the local network 101 is a cellular network, the access device 110 is preferred to preliminarily employ a method (such as SIP Name) for coupling to the access target device 150 via the cellular network.

The external network 102 is achieved by, for example, the Internet, a next generation network (NGN), and similar network. The NGN is a quality guaranteed closed network. While in the first embodiment, a description will be given of an example where the external network 102 is the Internet, the external network 102 is not limited to this.

The access device 110 accesses a function of the access target device 150. The access device 110 is achieved by, for example, a tablet terminal, a personal computer, a smart phone, a mobile phone, a digital television, a dedicated terminal, or similar device. The access device 110 is achieved by a hardware configuration with an ordinary computer. This ordinary computer includes a control unit such as a central processing unit (CPU), a storage device such as a read only memory (ROM) and a random access memory (RAM), an external storage device such as a hard disk drive (HDD) and a solid state drive (SSD), a display unit such as a display device, various input devices, and a communication I/F such as a NIC. While in the first embodiment, a description will be given of an example where the access device 110 is a tablet terminal connectable to the local network 101, the access device 110 is not limited to this.

The server 130 provides authorization other than authorization (hereinafter referred to as “user authorization”) by an owner of the access target device 150 to allow the access device 110 to access the function of the access target device 150. Any authorization other than the user authorization is possible insofar as the authorization is provided by a person who attempts to control the access of the access device 110 to a function of the access target device 150 except the owner of the access target device 150. The server 130 is achieved by a hardware configuration with an ordinary computer. This ordinary computer includes a control unit such as a CPU, a storage device such as a ROM and a RAM, an external storage device such as an HDD and an SSD, a display unit such as a display device, various input devices, and a communication I/F such as a NIC. In the first embodiment, the authorization other than the user authorization is an authorization (hereinafter referred to as “manufacturer authorization”) by a manufacturer of the access target device 150. The server 130 is a server operated by a manufacturing corporation and an affiliate corporation of the access target device 150 on the Internet. The first embodiment is not limited to these.

The access target device 150 has a target function to be accessed by the access device 110, and also provides the user authorization to allow the access device 110 to access the function of the access target device 150. The access target device 150 is achieved by, for example, a digital television, a personal computer, a hard disk recorder, a smart phone, a mobile phone, a tablet terminal, an air conditioner, an electric vehicle, an electric vehicle charger, a home energy management server (HEMS) as a communication device that controls equipment, or similar device. The access target device 150 is achieved by a hardware configuration with an ordinary computer. This ordinary computer includes a control unit such as a CPU, a storage device such as a ROM and a RAM, an external storage device such as an HDD and an SSD, a display unit such as a display device, various input devices, and a communication I/F such as a NIC. While in the first embodiment, a description will be given of an example where the access target device 150 is a digital television connectable to the local network 101, the access target device 150 is not limited to this.

As illustrated in FIG. 1, the access device 110 includes a first obtaining unit 111, a second obtaining unit 113, a storage unit 115, and an accessing unit 117. The first obtaining unit 111, the second obtaining unit 113, and the accessing unit 117 are achieved by, for example, execution of a program in a processor such as a CPU, or by software. The storage unit 115 is implemented in a storage that stores information with at least one of magnetic, optical, and electrical methods. The storage unit 115 may be, for example, an HDD, an SSD, a RAM, a memory card, or a similar type of storage.

The first obtaining unit 111 obtains the user authorization. Specifically, the first obtaining unit 111 communicates with the access target device 150 via the local network 101 so as to obtain the user authorization from the access target device 150. The first obtaining unit 111 obtains, for example, a user credential as the user authorization.

A communication protocol that is used to obtain the user credential by the first obtaining unit 111 employs, for example, HyperText Transfer Protocol (HTTP), File Transfer Protocol (FTP), Simple Mail Transfer Protocol (SMTP), Internet Message Access Protocol (IMAP), ECHONET Lite, a Smart Energy Profile 2 (SEP2), Constrained Application Protocol (CoAP), or similar protocol.

The communication protocol used by the first obtaining unit 111 may be determined by a predetermined program. Alternatively, the first obtaining unit 111 may obtain the communication protocol using a method for detecting equipment or service such as Universal Plug and Play (UPnP), multicast Domain Name System (mDNS), and Network Basic Input Output System (NetBIOS), and a similar object at a timing when obtaining the user credential.

The second obtaining unit 113 communicates with the server 130 via the local network 101 and the external network 102 so as to obtain the authorization other than the user authorization from the server 130. While in the first embodiment, the authorization other than user authorization is the manufacturer authorization, the authorization is not limited to this. The second obtaining unit 113 obtains, for example, a server credential as the manufacturer authorization.

Specifically, the second obtaining unit 113 transmits access device information, which is related to the access device 110, to the server 130. In the event that the second obtaining unit 113 succeeds in authorization of the access device information in the server 130, the second obtaining unit 113 determines a content to be authorized and then obtains the server credential corresponding to the authorized content. The access device information includes an ID of the manufacturer, a vendor, the owner, a unique ID, a model, a device type, or similar parameter of the access device 110, information indicating whether or not the access device 110 safely controls the user credential and the server credential, and similar information. This is because the user credential and the server credential are secret information. While the access device information is preferred to have signature of a third party or similar information to prevent impersonation, this is not mandatory.

The storage unit 115 stores the user authorization obtained by the first obtaining unit 111 and the manufacturer authorization obtained by the second obtaining unit 113. The storage unit 115 stores, for example, the user credential and the server credential.

The accessing unit 117 accesses the function of the access target device 150 via the local network 101 by using the user authorization and the manufacturer authorization. Specifically, in the event that the accessing unit 117 transmits the user credential and the server credential to the access target device 150 and succeeds in authorization of the user credential and the server credential in the access target device 150, the accessing unit 117 accesses the function of the access device 110.

Accessing the function (which is occasionally referred to as “a function access”) is performed as follows. For example, the access target device 150 returns a response to the access device 110 so as to provide the access device 110 with the function of the access target device 150 (that is, the access device 110 receives the function of the access target device 150). Providing the function of the access target device 150 to the access device 110 is performed as follows. For example, the access target device 150 returns a list of recorded content to the access device 110 as a response so as to display the list of recorded content of the access target device 150 in the access device 110.

The function access is not limited to this. The function access is also performed as follows. For example, the function access requests the access target device 150 for information (such as the list of recorded content) that is providable from the access target device 150 so as to obtain this information. Additionally, the function access may be performed as follows. For example, the function access may make the access target device 150 execute a function such as a modification of a state of the access target device 150. Making the access target device 150 execute the function is performed as follows. For example, the function access makes the access target device 150 change a channel. Alternatively, the process makes the access target device 150 operate the recorded content (playing back, deleting, or a similar operation).

The communication protocol used for the function access by the accessing unit 117 employs, for example, HTTP, FTP, SMTP, IMAP, ECHONET Lite, SEP2, CoAP, or similar protocol. The procedure where the accessing unit 117 accesses the function of the access target device 150 may be preliminarily determined by a program and a similar method. Alternatively, the accessing unit 117 may obtain the procedure using a method for detecting equipment or service such as UPnP, mDNS, NetBIOS, and a similar object at a timing when performing the function access.

The server 130 includes a second authorizing unit 131 as illustrated in FIG. 1. The second authorizing unit 131 is achieved by, for example, execution of a program in a processor such as a CPU, or by software.

The second authorizing unit 131 communicates with the access device 110 via the external network 102 and the local network 101 so as to issue the manufacturer authorization to the access device 110. The second authorizing unit 131 issues, for example, a server credential as the manufacturer authorization. While the server credential is provided with lifetime, the server credential is not limited to this.

Specifically, the second authorizing unit 131 receives the access device information from the access device 110, and then authorizes the received access device information. When the second authorizing unit 131 succeeds in the authorization, the second authorizing unit 131 determines a content to be authorized and then issues the server credential correspond to the authorized content. When the second authorizing unit 131 fails in the authorization, the second authorizing unit 131 does not issue the server credential.

As illustrated in FIG. 1, the access target device 150 includes a first authorizing unit 151 and a providing unit 153. The first authorizing unit 151 and the providing unit 153 are achieved by, for example, execution of a program in a processor such as a CPU, or by software.

The first authorizing unit 151 issues the user authorization to the access device 110 through communication with the access device 110 via the local network 101. The first authorizing unit 151 issues, for example, a user credential as the user authorization. While the user credential is provided with lifetime, the user credential is not limited to this. Specifically, in the event that the first authorizing unit 151 starts the communication with the access device 110, the first authorizing unit 151 displays a user authorization screen on a display device (not shown). In the event that the first authorizing unit 151 receives an authorization operation through the user authorization screen from the owner of the access target device 150, the first authorizing unit 151 transmits the user credential to the access device 110. The user authorization screen is displayed on, for example, a Webpage, an electric operation manual, and a similar medium.

FIG. 2 is a diagram illustrating an exemplary user authorization screen according to the first embodiment. In the example of FIG. 2, the owner of the access target device 150 selects a function to authorize the access device 110 to access the access target device 150 using a checkbox 10. Clicking an authorization button 11 allows the first authorizing unit 151 to receive the authorization operation of the owner. The user authorization screen may include information such as CAPCHA or similar information that is difficult for a computer to decipher. In addition to clicking the authorization button 11, the authorization operation of the owner may include input of information that is difficult for a computer to decipher. In addition to clicking the authorization button 11, the authorization operation of the owner may include input of information such as a character, a number, and similar data that are displayed on the display device of the access target device 150 and not readily accessible except the owner of the access target device 150. On the other hand, in the event that the owner clicks a rejection button 12 and then the first authorizing unit 151 receives a rejection operation from the owner, the first authorizing unit 151 does not transmit the user credential to the access device 110.

A list of target functions to be accessed by the access target device 150 may be controlled by the access target device 150 or controlled by the access device 110. When the list is controlled by the access device 110, the access device 110 simply transmits the list to the access target device 150.

The communication protocol used by the first authorizing unit 151 to issue the user credential may employ, for example, HTTP, FTP, SMTP, IMAP, ECHONET Lite, SEP2, CoAP, or a similar protocol. The communication protocol used by the first authorizing unit 151 may be preliminarily determined by a program or a similar method. Alternatively, the first obtaining unit 111 may obtain the communication protocol using a method for detecting equipment or service such as UPnP, mDNS, NetBIOS at a timing when obtaining the user credential. The first authorizing unit 151 is preferred to validate the communication with the aforementioned communication protocol after receiving the authorization operation from the owner of the access target device 150.

The first authorizing unit 151 may issue the same user credential every time. However, the user credential is information that basically needs to be a secret to anyone except the access device 110 and the access target device 150. Accordingly, the first authorizing unit 151 is preferred to issue a different user credential every time, and to issue a user credential that is changed at regular time intervals.

The providing unit 153 provides the access device 110 with the function based on the user authorization and the manufacturer authorization that are transmitted via the local network 101 from the access device 110. Specifically, the providing unit 153 receives the user credential and the server credential from the access device 110. Then, the providing unit 153 authorizes the user credential and the server credential, for example, determines lifetime of the received user credential and server credential. For example, the providing unit 153 authorizes the user credential itself, while the providing unit 153 communicates with the server 130 via the local network 101 and the external network 102 for authorization of the server credential.

Then, in the event that the providing unit 153 succeeds in the authorization, the providing unit 153 provides the access device 110 with a function of the target to be accessed via the local network 101. For example, the providing unit 153 transmits the list of recorded content of the access target device 150 to the access device 110, thus providing the access device 110 with a function that displays the list of recorded content. The providing unit 153 may execute the function of the access target device 150 on the access target device 150 instead of providing it to the access device 110.

The access device 110, the server 130, and the access target device 150 may not include all functional units described above as mandatory configuration, and may have configuration without a part of these units. For example, the access device 110 does not need to include the storage unit 115. In this case, the access device 110 simply obtains the user credential and the server credential every time the access device 110 performs the function access.

The functional units of the access device 110, the server 130, and the access target device 150 may be exchanged among the access device 110, the server 130, and the access target device 150. For example, the access device 110 may include the first authorizing unit 151 of the access target device 150.

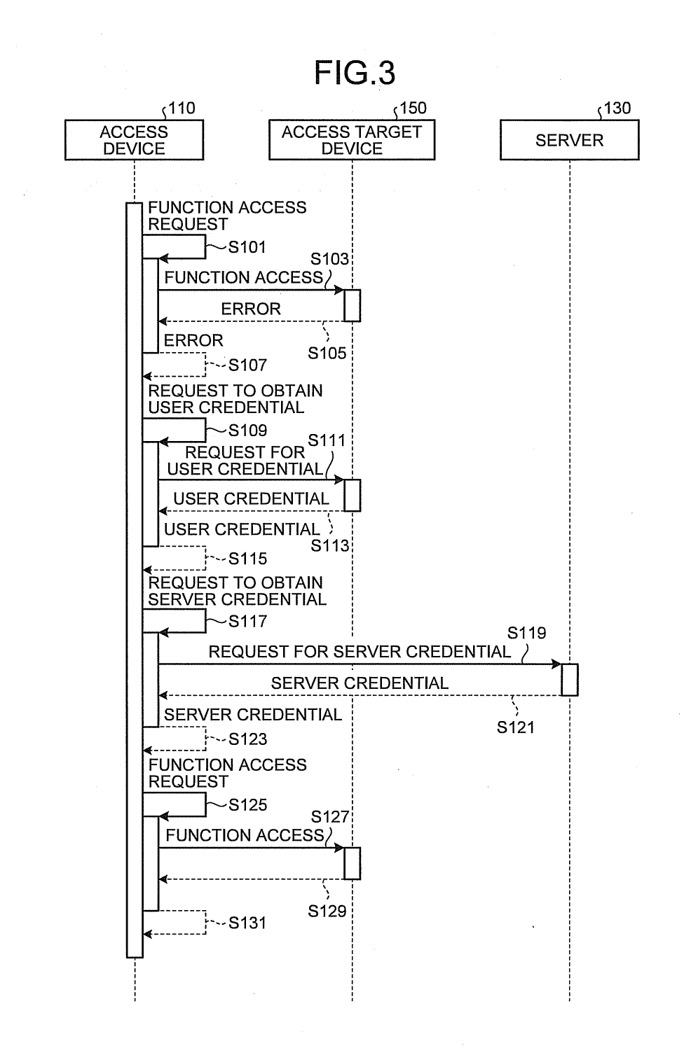

FIG. 3 is a sequence diagram illustrating an exemplary procedure of the function access process in the access system 100 according to the first embodiment.

First, the access device 110 requests the function access from the accessing unit 117 (step S101). Subsequently, the accessing unit 117 attempts to access the function of the access target device 150 via the local network 101 (step S103). However, the user credential and the server credential are not obtained at this point. Accordingly, the providing unit 153 transmits an error (rejection of the function access) to the accessing unit 117 via the local network 101 (step S105). The accessing unit 117 in turn returns the error to the access device 110 (step S107).

The user credential and the server credential are not stored in the storage unit 115 at step S101. In view of this, steps S101 to S107 may be omitted if it is preliminary known that the access device 110 needs the user credential and the server credential to perform the function access. The user credential and the server credential are not stored in the storage unit 115 at step S103 yet. In view of this, the accessing unit 117 may return the error to the access device 110 without attempting the function access. Accordingly, steps S103 and S105 may be omitted.

Subsequently, the access device 110 requests the first obtaining unit 111 to obtain the user credential (step S109). Subsequently, the first obtaining unit 111 requests the user credential from the first authorizing unit 151 via the local network 101 (step S111). Subsequently, the first authorizing unit 151 displays the user authorization screen as illustrated in FIG. 2. In the event that the first authorizing unit 151 receives the authorization operation from the owner of the access target device 150 through the user authorization screen, the first authorizing unit 151 transmits the user credential to the first obtaining unit 111 via the local network 101 (step S113). The first obtaining unit 111 in turn returns the user credential to the access device 110 (step S115). Subsequently, the access device 110 stores the user credential in the storage unit 115.

Subsequently, the access device 110 requests the second obtaining unit 113 to obtain the server credential (step S117). Subsequently, the second obtaining unit 113 transmits the access device information to the second authorizing unit 131 via the local network 101 and the external network 102, thus requesting the server credential (step S119). Subsequently, the second authorizing unit 131 authorizes the access device information. In the event that the second authorizing unit 131 succeeds in the authorization, the second authorizing unit 131 transmits the server credential to the second obtaining unit 113 via the external network 102 and the local network 101 (step S121). The second obtaining unit 113 in turn returns the server credential to the access device 110 (step S123). Subsequently, the access device 110 stores the server credential in the storage unit 115.

The obtaining order of the user credential and the server credential may be the user credential and the server credential in that order as described above, and may the server credential and the user credential in that order. Alternatively, the user credential and the server credential may be obtained at the same time.

Subsequently, the access device 110 obtains the user credential and the server credential from the storage unit 115, and then requests the function access from the accessing unit 117 again (step S125). Subsequently, the accessing unit 117 transmits the user credential and the server credential to the providing unit 153 via the local network 101, thus requesting the function access (step S127). Subsequently, the providing unit 153 authorizes the user credential and the server credential. In the event that the providing unit 153 succeeds in the authorization, the providing unit 153 provides a function of the target to be accessed to the access device 110 through the accessing unit 117 (steps S129 and S131).

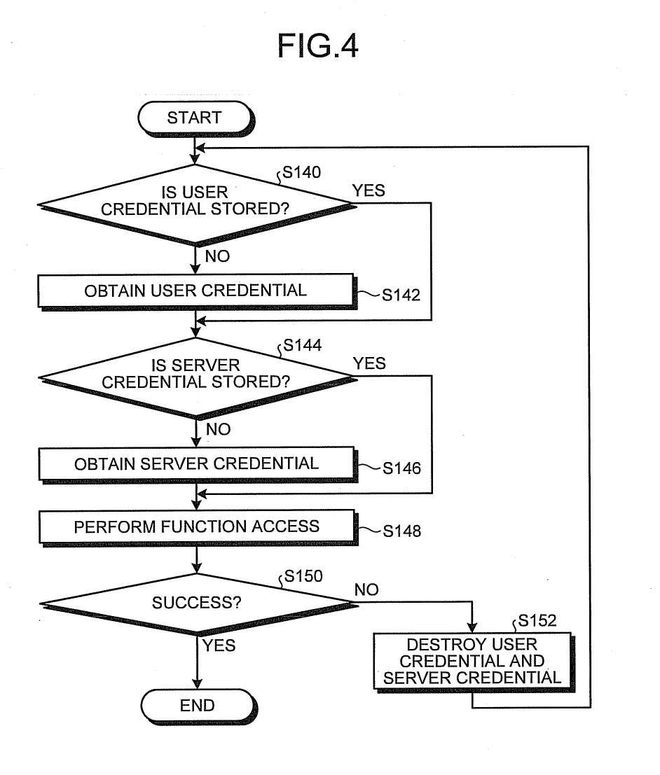

FIG. 4 is a flowchart illustrating the procedure of the function access process in the access system 100 according to the first embodiment.

First, the access device 110 determines whether or not the storage unit 115 stores the user credential (step S140). If the user credential is not stored (No in step S140), the first obtaining unit 111 obtains the user credential from the access target device 150 (step S142). The access device 110 stores the user credential in the storage unit 115. On the other hand, if the user credential is stored (Yes in step S140), the process of step S142 is not executed.

Subsequently, the access device 110 determines whether or not the storage unit 115 stores the server credential (step S144). If the server credential is not stored (No in step S144), the second obtaining unit 113 obtains the server credential from the server 130 (step S146). The access device 110 stores the server credential in the storage unit 115. On the other hand, if the server credential is stored (Yes in step S144), the process of step S146 is not executed.

The obtaining order of the user credential and the server credential may be the user credential and the server credential in that order as described above, or may be the server credential and the user credential in that order. The user credential and the server credential may be obtained at the same time.

Subsequently, the access device 110 obtains the user credential and the server credential from the storage unit 115. The accessing unit 117 attempts the function access to the access target device 150 by using the user credential and the server credential (step S148).

When the function access succeeds (Yes in step S150), the function of the access target device 150 is provided to the access device 110. On the other hand, when the function access fails (No in step S150), lifetime of the user credential or the server credential is likely to be expired. In view of this, the access device 110 destroys the user credential and the server credential in the storage unit 115 (step S152). The process returns to step S140, and then retries obtaining the user credential and the server credential.

The process may only destroy a credential with expired lifetime among the user credential and the server credential, and retry obtaining the credential with expired lifetime. When the owner of the access target device 150 does not explicitly cancel the authorization (approval) through the user authorization screen or a similar unit, the first authorizing unit 151 may reissue the user credential without authorization by the owner. When the owner of the access target device 150 explicitly cancel the authorization (approval) through the user authorization screen or a similar unit, the first authorizing unit 151 may issue an error without authorization by the owner (does not need to reissue the user credential).

As described above, with the first embodiment, the access target device 150 provides the user authorization, thus eliminating the need for user management in the server 130. This ensures the access authorization without the user management in the server 130. Especially, the first embodiment executes the user authorization of the access device 110 in the access target device 150. This provides the user authorization without providing the user information outside, thus improving security.

While in the first embodiment, the access device 110 and the access target device 150 are coupled to the server 130 via the local network 101 and the external network 102, the configuration is not limited to this. The access device 110 may be coupled to the server 130 not via the local network 101 but via the external network 102. For example, the access device 110 may be coupled to the server 130 via two external networks 102. In this case, the two external networks 102 are, for example, the external network 102, which couples the access device 110 to the Internet, and the Internet. In this case, the second obtaining unit 113 of the access device 110 communicates with the server 130 not via the local network 101 but via the external network 102.

### Second Embodiment

In a second embodiment, a description will be given of an example where an application (hereinafter referred to as “an app”) performs the function access. Difference from the first embodiment will be mainly described below. Like names and reference numerals designate elements with functions corresponding or similar to those of the first embodiment, and therefore such elements will not be further elaborated here.

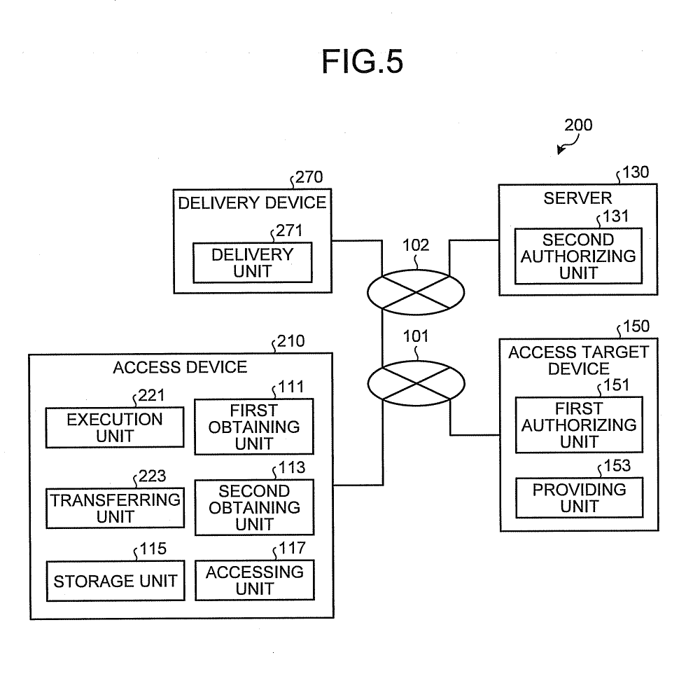

FIG. 5 is a block diagram illustrating an exemplary access system 200 according to the second embodiment. As illustrated in FIG. 5, the access system 200 in the second embodiment further includes a delivery device 270. An access device 210 in the second embodiment further includes an execution unit 221 and a transferring unit 223.

The delivery device 270 is coupled to the access device 210 via the external network 102 and the local network 101.

The delivery device 270 delivers an app to the access device 210. The delivery device 270 is achieved by a hardware configuration with an ordinary computer. The ordinary computer includes a control unit such as a CPU, a storage device such as a ROM and a RAM, an external storage device such as an HDD and an SSD, a display unit such as a display device, various input devices, and a communication I/F such as a NIC. While in the second embodiment, the app delivered by the delivery device 270 is a Web app that is executed on a browser and the delivery device 270 is a Web server on the Internet, the configuration is not limited to this.

The delivery device 270 includes a delivery unit 271 as illustrated in FIG. 5. The delivery unit 271 is achieved by, for example, execution of a program in a processor such as a CPU, or by software.

The delivery unit 271 delivers an app, which performs the function access, to the access device 210 via the external network 102 and the local network 101.

The execution unit 221 and the transferring unit 223 in the access device 210 are achieved by, for example, execution of a program in a processor such as a CPU, or by software. While in the second embodiment, the execution unit 221 and the transferring unit 223 perform functions of the web browser, the configuration is not limited to this.

The execution unit 221 executes the app delivered by the delivery device 270. Specifically, the execution unit 221 executes a Web app delivered by the delivery device 270. For example, the execution unit 221 performs rendering of HyperText Markup Language (HTML) and JavaScript (registered trademark), so as to operate the Web app on the web browser.

The transferring unit 223 transfers a first authorization from the first obtaining unit 111 to the second obtaining unit 113. Specifically, the transferring unit 223 transfers the user credential obtained by the first obtaining unit 111 to the second obtaining unit 113 such that the Web app does not recognize the user credential. When the second obtaining unit 113 obtains a second authorization in advance, the transferring unit 223 may transfer the second authorization from the second obtaining unit 113 to the first obtaining unit 111. Specifically, the transferring unit 223 transfers the server credential obtained by the second obtaining unit 113 to the first obtaining unit 111 such that the Web app does not recognize the server credential.

The first obtaining unit 111 obtains the first authorization in accordance with an instruction from the Web app. In the second embodiment, the first obtaining unit 111 displays the user authorization screen on the web browser of the access device 210. Similarly to the first embodiment, the first authorizing unit 151 may display the user authorization screen.

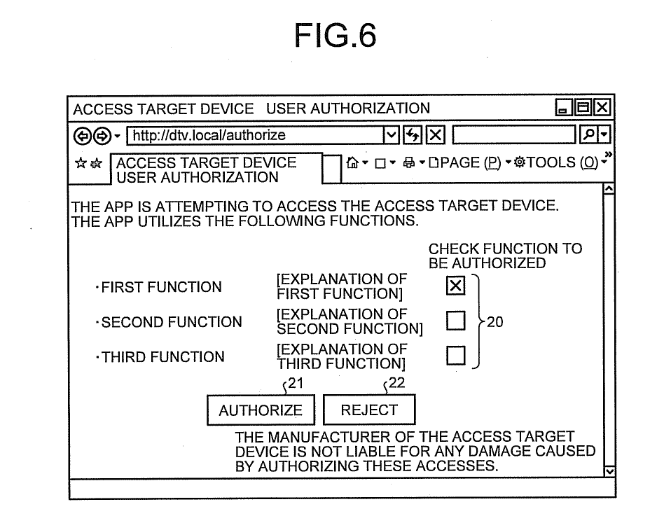

FIG. 6 is a diagram illustrating an exemplary user authorization screen according to the second embodiment. In the example of FIG. 6, when the owner of the access target device 150 selects a function to authorize the Web app to access the access target device 150 by using a checkbox 20 and then clicks an authorization button 21, the first obtaining unit 111 receives the authorization operation of the owner and then requests the user credential from the first authorizing unit 151. On the other hand, when the owner clicks a rejection button 22 and the first obtaining unit 111 receives the rejection operation of the owner, the first obtaining unit 111 does not request the user credential from the first authorizing unit 151.

When the second obtaining unit 113 obtains the second authorization in advance, the first obtaining unit 111 may transmit the second authorization transferred by the transferring unit 223 to the access target device 150 and then obtain the first authorization, which doubles as the second authorization, from the access target device 150. In this case, the first obtaining unit 111 may pass the first authorization, which doubles the second authorization, to the Web app. The first authorization, which doubles as the second authorization, is the encrypted second authorization for example.

The second obtaining unit 113 transmits the first authorization transferred from the transferring unit 223 to the server 130, and obtains the second authorization, which doubles as the first authorization, from the server 130. The second authorization, which doubles as the first authorization, is the encrypted first authorization for example. The second obtaining unit 113 passes the second authorization, which doubles the first authorization, to the Web app.

In the case where the second obtaining unit 113 obtains the second authorization in advance, the second obtaining unit 113 may obtain the second authorization based on an instruction from the Web app.

The accessing unit 117 employs the second authorization, which doubles as the first authorization, passed from the Web app so as to perform the function access. However, in the case where the accessing unit 117 is able to obtain the second authorization, which doubles as the first authorization, from the second obtaining unit 113 not through the Web app, the accessing unit 117 directly obtains the second authorization from the second obtaining unit 113.

In the case where the second obtaining unit 113 obtains the second authorization in advance, the accessing unit 117 may employ the first authorization, which doubles as the second authorization, passed from the Web app so as to perform the function access. However, in the case where the accessing unit 117 is able to obtain the first authorization, which doubles as the second authorization, from the first obtaining unit 111 not through the Web app, the accessing unit 117 directly obtains the first authorization from the first obtaining unit 111.

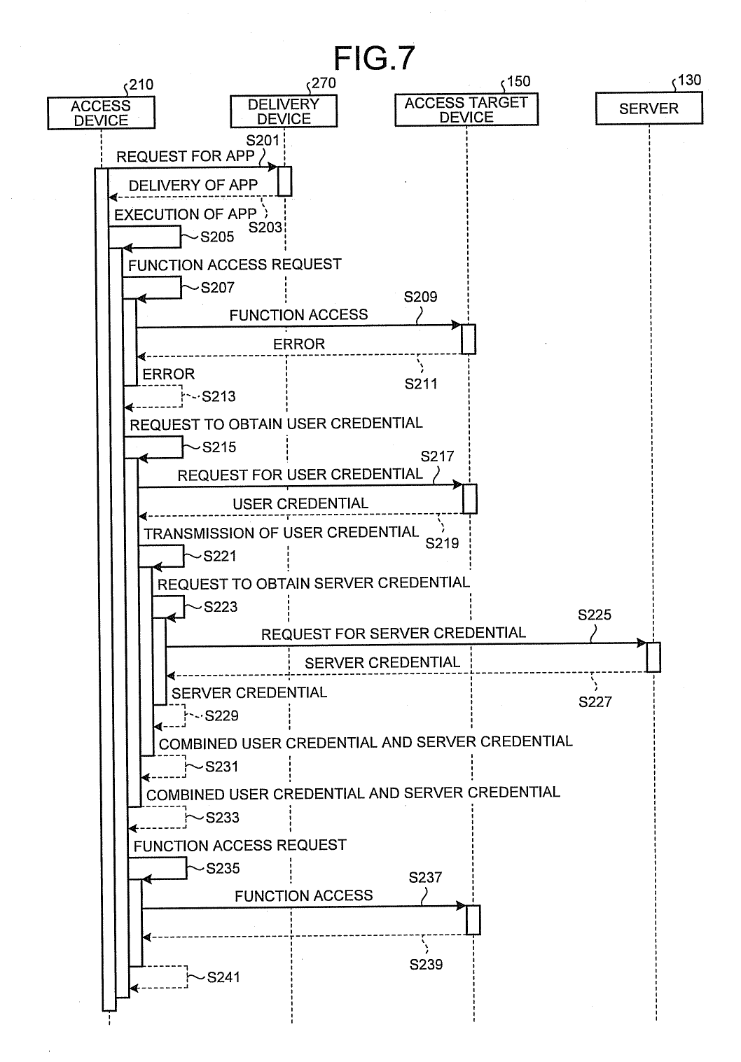

FIG. 7 is a sequence diagram illustrating a procedure of the function access process executed in the access system 200 according to the second embodiment.

First, the execution unit 221 requests the Web app, which performs the function access, from the delivery unit 271 via the local network 101 and the external network 102 (step S201). For example, the execution unit 221 accesses a uniform resource locator (URL) of the delivery unit 271 (a Web server) from the web browser of the access device 210, so as to request the Web app. Subsequently, the delivery unit 271 delivers the requested Web app to the execution unit 221 via the external network 102 and the local network 101 (step S203). Subsequently, the execution unit 221 executes the Web app delivered from the delivery unit 271 (step S205). Accordingly, the Web app operates on the web browser of the access device 210.

Subsequently, the Web app requests the accessing unit 117 to perform the function access (step S207). For example, the Web app calls JavaScript API (the app Program Interface) to perform the function access, and then requests the accessing unit 117 to perform the function access. Subsequently, the accessing unit 117 attempts to access the function of the access target device 150 via the local network 101 (step S209). For example, the accessing unit 117 transmits an HTTP request to the providing unit 153 (a Web server), and then attempts to access the function of the access target device 150. The user credential and the server credential are not obtained at this point yet. Accordingly, the providing unit 153 transmits an error (rejection of the function access) to the accessing unit 117 via the local network 101 (step S211). Subsequently, the accessing unit 117 in turn returns the error to the Web app (step S213).

The user credential and the server credential are not stored in the storage unit 115 at step S207. In view of this, steps S207 to S213 may be omitted if it is preliminary known that the Web app needs the user credential and the server credential to perform the function access. The storage unit 115 in the second embodiment may employ, for example, Cookie, WebSQL, WebStorage, IndexedDB, or a similar storage. The user credential and the server credential are not stored in the storage unit 115 at step S103 yet. In view of this, the accessing unit 117 may return the error to the Web app without attempting the function access. Accordingly, steps S209 and S211 may be omitted.

Subsequently, the Web app redirects the web browser of the access device 210 to a URL of the first authorizing unit 151 (a Web server). The redirection cancels the Web app that is being displayed or to be displayed on the web browser, and replaces the access with an access to another URL. The URL of the first authorizing unit 151 may be preliminarily stored in the access device 210, or may be obtained via a network, for example, when obtaining the Web app. Additionally, the URL of the first authorizing unit 151 may be obtained by a method for detecting equipment or service such as UPnP, mDNS, NetBIOS at a timing when the URL is redirected.

Subsequently, the first authorizing unit 151 transmits information for displaying the user authorization screen in FIG. 6 to the first obtaining unit 111 as an HTTP response to the redirection. Accordingly, the first obtaining unit 111 displays the user authorization screen in FIG. 6 on the web browser of the access device 110. The Web app assigns an application ID of the Web app when redirecting the web browser. Accordingly, the first authorizing unit 151 may include information related to the Web app such as a name of the Web app and a function name of an access target in the information for displaying the user authorization screen. This consequently allows the first obtaining unit 111 to display the name of the Web app, the function name of the access target, and similar information on the user authorization screen as illustrated in FIG. 6. While the app ID is preferred to have signature of a third party or similar information to prevent impersonation, this is not mandatory.

The information related to the Web app may be preliminarily stored in the access target device 150 as information associated with the app ID. Alternatively, the information related to the Web app may be obtained from an app ID management server (not shown) or a similar server by the access target device 150 through communication when the access target device 150 first connects to a network, configures initial setting, requests the user credential, issues the user credential, or executes a similar process. If the Web app has assigned the information related to the Web app when redirecting the web browser, the access target device 150 may employ the assigned information related to the Web app.

Subsequently, in the event that the owner of the access target device 150 perform the authorization operation through the user authorization screen in FIG. 6, the first obtaining unit 111 receives this operation as a request for obtaining the user credential (step S215). The first obtaining unit 111 then transmits an HTTP request to the first authorizing unit 151, thus requesting the user credential (step S217). Subsequently, the first authorizing unit 151 transmits the user credential to the first obtaining unit 111 as an HTTP response (step S219). At this time, the first authorizing unit 151 instructs the first obtaining unit 111 to employ the transferring unit 223. For example, the first authorizing unit 151 provides an HTTP response of the first authorizing unit 151 as a redirection to the URL of the second authorizing unit 131 (a Web server) so as to instruct the first obtaining unit 111 to employ the transferring unit 223. Subsequently, in the event that the first obtaining unit 111 receives the user credential along with the instruction indicative of use of the transferring unit 223, the first obtaining unit 111 passes the user credential to not the Web app but the transferring unit 223 (step S221). The transferring unit 223 passes the user credential to the second obtaining unit 113 so as to request obtainment of the server credential (step S223). This avoids notifying the Web app about the user credential that is secret information, thus improving safety.

On the other hand, in the event that the owner of the access target device 150 performs the rejection operation through the user authorization screen in FIG. 6, the first obtaining unit 111 does not request the user credential from the first authorizing unit 151, and the first authorizing unit 151 in turn does not transmit the user credential to the first obtaining unit 111. At this time, the web browser of the access device 210 redirects the URL of the first authorizing unit 151 to the URL of the delivery unit 271. This consequently notifies the Web app about the error.

Subsequently, the second obtaining unit 113 transmits the user credential and access device information to the second authorizing unit 131 via the local network 101 and the external network 102, thus requesting the server credential (step S225). For example, the second obtaining unit 113 transmits the user credential and access device information to the second authorizing unit 131 as the HTTP request, thus requesting the server credential.

Subsequently, in the event that the second authorizing unit 131 authorizes the access device information and succeeds in the authorization, the second authorizing unit 131 generates the server credential, which doubles as the user credential (hereinafter referred to as “a combined user credential and server credential”). Subsequently, the second authorizing unit 131 transmits the combined user credential and server credential to the second obtaining unit 113 via the external network 102 and the local network 101 (step S227). The second authorizing unit 131 stores, for example, a secret key corresponding to granularity of the access device information. The second authorizing unit 131 encrypts the user credential with the secret key, thus generating the combined user credential and server credential. A public key, which is paired with the secret key, may be preliminarily stored in the access target device 150. Alternatively, the public key may be obtained from the second authorizing unit 131 or a similar unit by the access target device 150 through communication when the access target device 150 first connects to a network, configures initial setting, requests the user credential, issues the user credential, or executes a similar process.

Subsequently, the second obtaining unit 113 returns the combined user credential and server credential to the Web app through the transferring unit 223 or a similar unit (steps S229 to S233). The Web app stores the combined user credential and server credential in the storage unit 115.

Subsequently, the Web app obtains the combined user credential and server credential from the storage unit 115, and then requests the accessing unit 117 to perform the function access again (step S235). Subsequently, the accessing unit 117 transmits the combined user credential and server credential to the providing unit 153 via the local network 101, thus requesting the function access (step S237). Subsequently, the providing unit 153 employs the public key to decrypt the combined user credential and server credential, and then extracts the user credential, so as to authorize the user credential. Success of the authorization of the user credential means a success of the authorization of the server credential. Accordingly, the providing unit 153 provides the Web app with a function of the target to be accessed through the accessing unit 117 (steps S239 and S241).

The user credential and the server credential may be obtained by a method similar to the first embodiment.

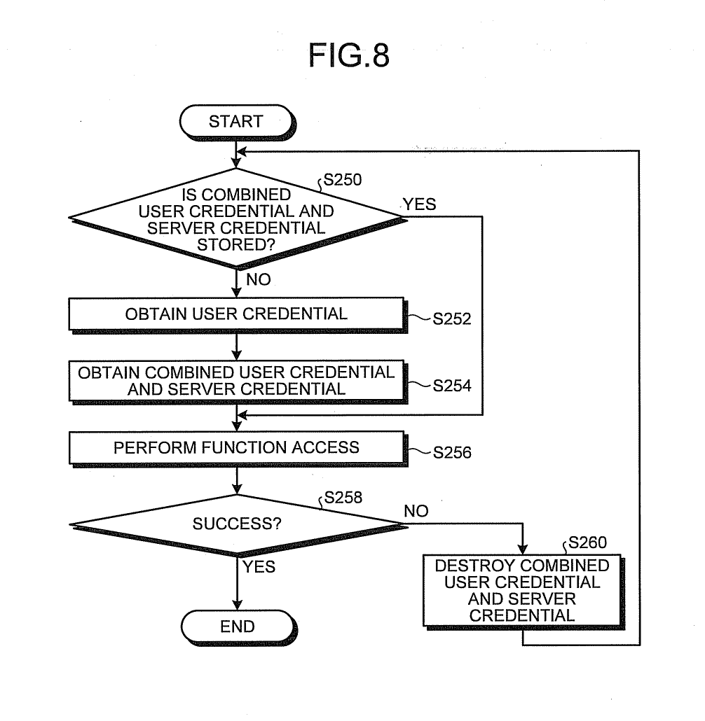

FIG. 8 is a flowchart illustrating an exemplary procedure of the function access process in the access system 200 according to the second embodiment.

First, the Web app determines whether or not the storage unit 115 stores the combined user credential and server credential (step S250). If the combined user credential and server credential are not stored (No in step S250), the first obtaining unit 111 obtains the user credential from the access target device 150 (step S252). The transferring unit 223 transfers the user credential from the first obtaining unit 111 to the second obtaining unit 113. The second obtaining unit 113 transmits the user credential to the server 130 to obtain the combined user credential and server credential from the server 130 (step S254). On the other hand, if the combined user credential and server credential are stored (Yes in step S250), steps S252 and S254 are not executed.

Subsequently, the Web app obtains the combined user credential and server credential from the storage unit 115. Then, the accessing unit 117 attempts the function access to the access target device 150 by using the combined user credential and server credential (step S256).

When the function access succeeds (Yes in step S258), the function of the access target device 150 is provided to the Web app. On the other hand, when the function access fails (No in step S258), lifetime of the user credential or the server credential is likely to be expired. Accordingly, the Web app destroys the combined user credential and server credential in the storage unit 115 (step S260). The process returns to step S250, and then retries obtaining the user credential and the server credential.

For example, in the case where lifetime of the server credential is expired, the server credential is encrypted with an old secret key. Subsequently, the combined user credential and server credential is decrypted with a new public key. Accordingly, the combined user credential and server credential fails in decrypting. Thus, the function access fails. For example, in the case where lifetime of the user credential is expired, the user credential is obtained by decrypting the combined user credential and server credential and then fails in the authorization. Thus, the function access fails.

As described above, even in the case where the Web app performs the function access, the second embodiment hides the user credential from the Web app, which possibly leaks the secret information, thus ensuring improved security. Especially, even in the case where the Web app is an unauthorized app, the second embodiment is able to keep the user credential secret, thus ensuring improved security.

Even in the case where the Web app performs the function access, the second embodiment is able to hide the server credential from the Web app, which might leak the secret information.

### Third Embodiment

In a third embodiment, a description will be given of an example where an authorization device different from the access target device performs the user authorization. Difference from the second embodiment will be mainly described below. Like names and reference numerals designate elements with functions corresponding or similar to those of the second embodiment, and therefore such elements will not be further elaborated here.

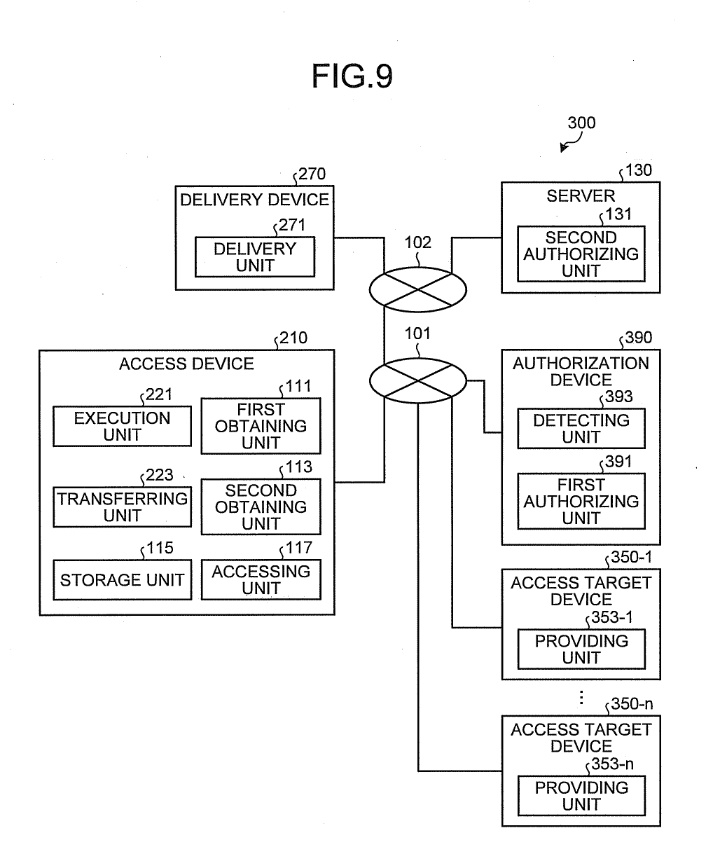

FIG. 9 is a block diagram illustrating an exemplary access system 300 according to the third embodiment. As illustrated in FIG. 9, the access system 300 in the third embodiment further includes a plurality of access target devices 350-1 to 350-n (n≧2) and an authorization device 390.

The access device 210, the plurality of access target devices 350-1 to 350-n, and the authorization device 390 are coupled together via the local network 101. The plurality of access target devices 350-1 to 350-n may be coupled to the authorization device 390 via a network other than the local network 101. The number of the access target device may be one.

The plurality of access target devices 350-1 to 350-n each have a function of a target to be accessed by the access device 210. The plurality of access target devices 350-1 to 350-n are achieved by, for example, a home appliance (a digital television, an air conditioner, a lighting, a refrigerator, a microwave oven, or a similar appliance), a personal computer, a hard disk recorder, a smart phone, a mobile phone, a tablet terminal, an electric vehicle, an electric vehicle charger, a fuel cell, a solar cell, a storage battery, a sensor, or a similar device.

The plurality of access target devices 350-1 to 350-n includes respective providing units 353-1 to 353-n as illustrated in FIG. 9. The providing units 353-1 to 353-n are similar to the providing unit 153 in the first and second embodiments, and will not be further elaborated here.

The authorization device 390 performs the user authorization to allow the access device 210 to access the functions of the plurality of access target devices 350-1 to 350-n. The authorization device 390 is achieved by, for example, a digital television, a personal computer, a hard disk recorder, a smart phone, a mobile phone, a tablet terminal, a charge management unit, a home energy management server (HEMS) as a communication device that controls equipment, or similar device. The authorization device 390 is achieved by a hardware configuration with an ordinary computer. This ordinary computer includes a control unit such as a CPU, a storage device such as a ROM and a RAM, an external storage device such as an HDD and an SSD, a display unit such as a display device, various input devices, and a communication I/F such as a NIC.

As illustrated in FIG. 9, the authorization device 390 includes a first authorizing unit 391 (a typical authorizing unit) and a detecting unit 393.

The detecting unit 393 detects change (for example, participation and disengagement) in connection of the plurality of access target devices 350-1 to 350-n with the local network 101.

The first authorizing unit 391 is similar to the first authorizing unit 151 in the first and second embodiments. However, in the event that the detecting unit 393 detects any change in connection of the plurality of access target devices 350-1 to 350-n with the local network 101, the first authorizing unit 391 invalidates the issued user authorization. For example, in the event that the detecting unit 393 detects connection of a new access target device with the local network 101, the first authorizing unit 391 invalidates an issued user credential. In view of this, if the accessing unit 117 performs the function access using this user credential, the function access fails.

The access system 300 operates basically similarly to operation in the second embodiment. However, the target of the function access by the accessing unit 117 is any of the plurality of access target devices 350-1 to 350-n. The target of the first obtaining unit 111 to obtain the user credential is the authorization device 390.

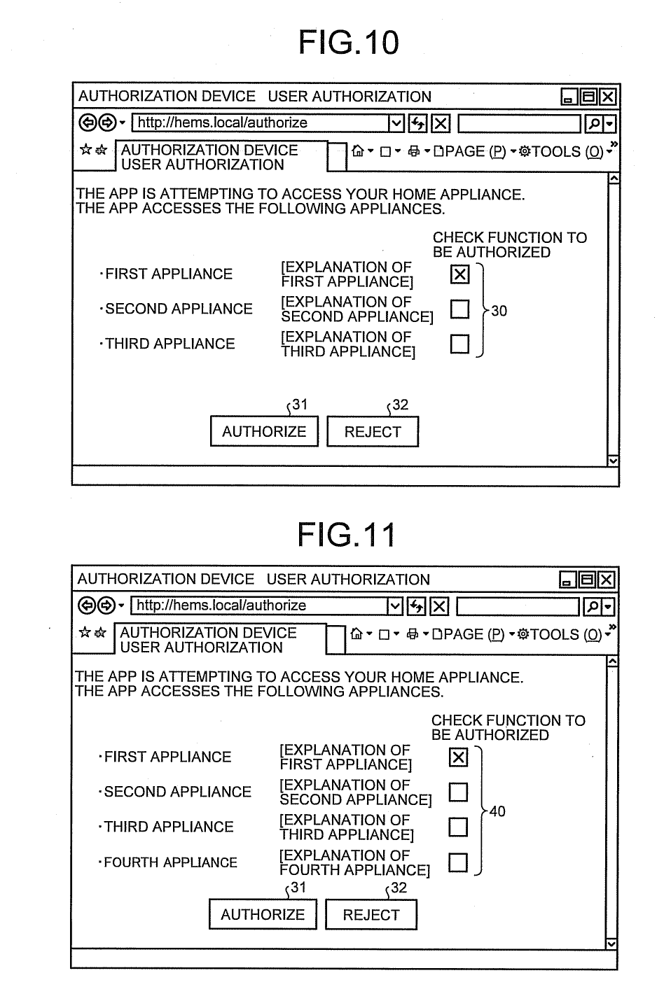

In the third embodiment, the first obtaining unit 111 displays a user authorization screen in FIG. 10. FIG. 10 is a diagram illustrating an exemplary user authorization screen according to the third embodiment. In the example of FIG. 10, when the owner of the access target device 150 selects a home appliance (an access target device) where the Web app is authorized to access using a checkbox 30 and clicks an authorization button 31, the first obtaining unit 111 receives the authorization operation of the owner. Subsequently, the first obtaining unit 111 requests the user credential from the first authorizing unit 391. On the other hand, when the owner clicks a rejection button 32 and then the first obtaining unit 111 receives the rejection operation of the owner, the first obtaining unit 111 does not request the user credential from the first authorizing unit 391.

In the event that the detecting unit 393 detects a new connection of the access target device with the local network 101, the first authorizing unit 391 invalidates the issued user credential. Accordingly, in the event that the accessing unit 117 performs the function access using this user credential, this function access fails. This allows the first obtaining unit 111 to request the first authorizing unit 391 to issue the user credential again. In this respect, the user authorization screen displayed by the first obtaining unit 111 includes the new home appliance (the access target device) detected by the detecting unit 393 as illustrated in FIG. 11. This allows obtaining the user authorization for the new home appliance (the access target device).

In the case where the plurality of access target devices 350-1 to 350-n are coupled to the authorization device 390 via a network other than the local network 101, the accessing unit 117 accesses the functions of the plurality of access target devices 350-1 to 350-n through the authorization device 390. In this case, a communication protocol between the accessing unit 117 and the authorization device 390 employs, for example, an HTTP or a similar protocol. A communication protocol among the authorization device 390 and the plurality of access target devices 350-1 to 350-n employs, for example, ECHONET Lite, SEP2, or a similar protocol.

In this case, the authorization device 390 is able to serve as a part of functions of the providing units 353-1 to 353-n. More specifically, the authorization device 390 receives the first authorization and the second authorization from the access device 210 instead of the providing units 353-1 to 353-n. The authorization device 390 then authorizes the received first authorization and second authorization. In this case, the providing units 353-1 to 353-n do not authorize the first authorization and the second authorization. The providing units 353-1 to 353-n simply provide functions with the access device 210 only, based on the authorization result of the authorization device 390. The authorization device 390 may authorize one of the first authorization and the second authorization instead of authorizing both of them.

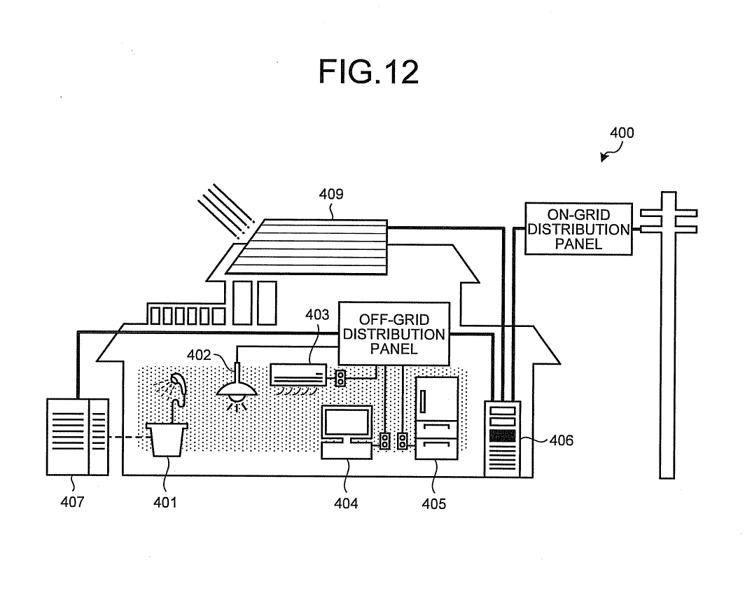

FIG. 12 is a schematic diagram illustrating an example of the plurality of access target devices 350-1 to 350-n in the case where the access system 300 is applied to a smart grid system 400 according to the third embodiment. In this case, the plurality of access target devices 350-1 to 350-n correspond to a bathroom 401, a light 402, an air conditioner 403, a digital television 404, a refrigerator 405, a storage battery 406, a fuel cell 407, a solar panel 409, and a similar device.

As described above, with the third embodiment, in the event that a new access target device is detected, the issued user credential is invalidated. This avoids the function access to the new access target device without the user authorization for the new access target device.

Modification

While in each aforementioned embodiment, the access device obtains the user credential via the local network, the method for obtaining the user credential is not limited to this. For example, the access device may obtain the user credential from the access target device through a QR code (registered trademark), near field communication, the media, or a similar method. The access device may obtain the user credential by user's manual input. In these cases, the access device reads the QR code, the access device is moved to the access target device in a position where near field communication is possible, or the user credential is manually input. These allow determining that the user intends to perform authorization.

In the first embodiment, the access target device may provide the access device with a function of a target to be accessed, similarly to the third embodiment. The authorization device may allow the owner of the access target device to authorize the access device to access the function of the access target device.

Hardware Configuration

A program, which is executed by the access device in each embodiment and modification described above, is provided as a file in an installable format or an executable format. This program is stored in a computer-readable media such as a CD-ROM, a CD-R, a memory card, a DVD, and a flexible disk (FD).

The program, which is executed by the access device in each embodiment and modification described above, may be stored on a computer coupled to a network such as the Internet, and may be downloaded via the network. The program, which is executed by the access device in each embodiment and modification described above, may be distributed via a network such as the Internet.

The program, which is executed by the access device in each embodiment and modification described above, may be preliminarily stored in a ROM or a similar storage.

The program, which is executed by the access device in each embodiment and modification described above, has a module configuration to implement the respective units described above on a computer. As actual hardware, for example, the control unit is configured to read out and execute the program in the storage unit from the external memory so as to implement the respective units on the computer.

Each embodiment and modification eliminates user management in the server.

For example, the respective steps in the flowchart of each of the aforementioned embodiments may be executed in a modified execution order, executed at the same time, or executed in a different execution order for each execution insofar as the execution is compatible with the respective steps.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An access device, comprising:
a first obtaining unit configured to obtain a first authorization as user authorization;
a second obtaining unit configured to obtain a second authorization as authorization other than the user authorization through communication with a server via an external network; and
an accessing unit configured to access a function of an access target device via a local network by using the first authorization and the second authorization.

2. The access device according to claim 1, wherein
the first obtaining unit communicates with one of the access target device and an authorization device via the local network to obtain the first authorization.

3. The access device according to claim 2, further comprising:
an execution unit configured to execute an application program that accesses the function of the access target device via the local network; and
a transferring unit configured to transfer the first authorization from the first obtaining unit to the second obtaining unit, wherein
the first obtaining unit obtains the first authorization in accordance with an instruction from the application program,
the second obtaining unit transmits the transferred first authorization to the server to obtain the second authorization doubling as the first authorization from the server, and
the accessing unit accesses the function of the access target device via the local network by using the second authorization doubling as the first authorization.

4. The access device according to claim 3, wherein
the application program is a Web application program,
the second authorization doubling as the first authorization is encrypted information of the first authorization,
the second obtaining unit passes the second authorization doubling as the first authorization to the Web application program, and
the accessing unit accesses the function of the access target device via the local network by using the second authorization doubling as the first authorization passed from the Web application program.

5. The access device according to claim 2, further comprising:
an execution unit configured to execute an application program that accesses the function of the access target device via the local network; and
a transferring unit configured to transfer the second authorization from the second obtaining unit to the first obtaining unit, wherein
the second obtaining unit obtains the second authorization in accordance with an instruction from the application program,
the first obtaining unit transmits the transferred second authorization to one of the access target device and the authorization device to obtain the first authorization doubling as the second authorization from one of the access target device and the authorization device, and
the accessing unit accesses the function of the access target device via the local network by using the first authorization doubling as the second authorization.

6. The access device according to claim 5, wherein
the application program is a Web application program,
the first authorization doubling as the second authorization is encrypted information of the second authorization,
the first obtaining unit passes the first authorization doubling as the second authorization to the Web application program, and
the accessing unit accesses the function of the access target device via the local network by using the first authorization doubling as the second authorization passed from the Web application program.

7. The access device according to claim 1, wherein the accessing unit receives the function provided via the local network from the access target device when authorization of the first authorization and the second authorization by the access target device succeeds.

8. The access device according to claim 1, wherein the second authorization is a manufacturer authorization by a manufacturer of the access target device.

9. An access system, comprising:
an access device;
an authorization device coupled to the access device via a local network, wherein
the access device includes
a first obtaining unit configured to obtain a first authorization as user authorization through communication with the authorization device via the local network;
a second obtaining unit configured to obtain a second authorization as authorization other than the user authorization through communication with a server via an external network; and
an accessing unit configured to access a function of an access target device via the local network by using the first authorization and the second authorization, wherein
the authorization device includes
an authorizing unit configured to issue the user authorization; and
a detecting unit configured to detect change in connection of the access target device with the local network, and
the authorizing unit invalidates the user authorization when the change in connection of the access target device is detected.

10. A computer program product comprising a computer-readable medium containing a program executed by a computer, the program causing the computer to execute:
firstly obtaining a first authorization as user authorization;
secondly obtaining a second authorization as an authorization other than the user authorization through communication with a server via an external network; and
accessing a function of an access target device via a local network by using the first authorization and the second authorization.
